(19) United States
(12) Patent Application Publication
(10) Pub. No.: US 2009/0150233 A1
(43) Pub. Date: Jun. 11, 2009

(54) COLLABORATIVE ADVERTISMENT METHOD AND SYSTEM

(76) Inventors: Kelly Byrnes, Santa Barbara, CA (US); Greg Byrnes, Santa Barbara, CA (US)

Correspondence Address: ITALIA IP, 3500 WEST OLIVE AVE., SUITE 300, BURBANK, CA, 91505, US

(21) Appl. No.: 11/952,420

(22) Filed: Dec. 7, 2007

(51) Int. Cl. G06Q 30/00

(52) U.S. Cl. 705/14

(57) ABSTRACT

This application discloses a method of generating a collaborative advertisement, the method comprising the steps of: at least two autonomous entities coming together to create an advertisement; the entities sharing substantially all the costs for the production of the advertisement in some proportion; and, wherein each entity does so with the sole intent of benefiting individually and without regard to any direct benefit to any other entity.

### BACKGROUND OF INVENTION

This application relates generally to the field of marketing and advertising. More specifically, this application relates to a collaborative advertising method and system wherein at least two autonomous advertisers work together to create an advertising campaign, share the expense of the campaign, and do so with the sole intent of benefiting individually and without regard to any direct benefit to the other.

### SUMMARY

In the fields of marketing and advertising, the ultimate goal of most advertisers is to cost-effectively increase sales of their goods or services. Therefore, a particular advertisement or advertising campaign is deemed successful if it results in an increase in sales and revenue, net of advertising costs. The question of whether a specific ad campaign is effective, can generally be determined by evaluating its effect on factors such as, customer loyalty, brand name recognition and brand name distribution.

Many different marketing and advertising schemes have been devised and broadly implemented in an effort to find the most effective and least costly way of increasing sales. One popular form of advertising is co-operative advertising. Co-operative advertising is generally defined as advertising featuring both a local and a national advertiser where they both share the cost of a particular advertisement. Co-operative advertising is often used by national advertisers as an incentive to sell-in more product to their retailers. An example of a typical co-operative advertisement would be a Nike (national advertiser) ad that indicates that Nike shoes can be purchased at the neighborhood retailer, Footlocker (local advertiser). A key characteristic to co-operative advertisement is that each advertiser is directly linked to the other, such that if one advertiser benefits from the ad, the other advertiser also benefits. Using our example, if Footlocker sells more Nike shoes, Nike directly benefits. And if consumers come to Footlocker looking for Nike shoes to purchase, Footlocker directly benefits. Although this is but one example, all forms of co-operative advertising have this general characteristic of a directly linked mutual benefit.

By contrast, this application discloses a collaborative advertising method and system whereby two autonomous entities work together to create an advertisement, share all costs (production costs of the advertisement and/or media buy) in some proportion, and do so with the sole intent of benefiting individually and without regard to any direct benefit to the other. A collaborative advertisement is further characterized, and distinguished from co-operative advertising, by the following: two entities come together for the one goal, producing the advertisement; the advertisement may or may not influence the other entity's sales; whether or not the two entities are previously connected in any context is of no concern, in fact the two entities may or may not have any commonalities (Adidas and Pepsi) or may even be competitors (Pepsi and Coke). A basic example of a collaborative ad would be a television advertisement where a person is shown running in his new Adidas running shoe, and once she arrives at her destination, she is handed a Pepsi to quench her thirst.

Entities are inclined to produce a collaborative advertisement even though there is no direct or indirect relationship between them for a number of reasons, including: 1) two entities with smaller advertising budgets will be able to combine their funds to afford a better time slot and/or higher production quality then they would if that had to do it alone; 2) two entities would be able to save on advertising costs by splitting the cost if the same time slot and/or production quality is used; and 3) higher impact advertising due to the innovative collaborative approach.

The collaborative ad may be further characterized and distinguished from co-operative advertisements when the collaborative advertisement is produced under the umbrella of a third party organization. Disclosed herein is a collaborative advertisement whereby two autonomous entities come together to produce the advertisement as described above, but in addition, the advertisement is brought about by a third party organization. In this embodiment, the third party organization provides a means for the two entities to come together. Additionally, when the third party is a charitable organization that endorses the advertisement, the entities receive a number of additional benefits to those described above such as a boost in public relations for each entity, especially when the third party charitable organization requires certain standards before granting the endorsement to the collaborative ad. A basic example of a collaborative ad under the umbrella of a third party charitable organization would include the subject matter of the collaborative television advertisement described above ending in a image or voiceover that indicates that the entities of the ad (Adidas and Pepsi) came together for the benefit of the charitable organization.

In particular, this application discloses a method of generating a collaborative advertisement, the method comprising the steps of: at least two autonomous entities coming together to create an advertisement; the entities sharing substantially all the costs of the advertisement in some proportion; and, wherein each entity does so with the sole intent of benefiting individually and without regard to any direct benefit to any other entity.

This application also discloses a method of generating a collaborative advertisement under the umbrella of a third party charitable organization, the method comprising the steps of: at least two autonomous entities coming together to create an advertisement, wherein at least one of the entities is listed on a website operated by the third party charitable organization, wherein the website provides entities the ability to list their charitable contributions and an indication that the entities listed on the website have met certain criteria set by the third party charitable organization in order to be listed on the website; the entities sharing substantially all the costs of the advertisement in some proportion; wherein each entity does so with the sole intent of benefiting individually and without regard to any direct benefit to any other entity; and, wherein the collaborative advertisement type is selected from the group consisting of display, television, radio, internet, direct mail, print, and promotional.

This application further discloses a method of facilitating a collaborative advertisement by a third party organization, the method comprising the steps of: at least two autonomous entities coming together to create an advertisement; wherein at least one of the entities is listed on a website operated by the third party organization; the entities sharing substantially all the costs of the advertisement in some proportion; wherein each entity does so with the sole intent of benefiting individually and without regard to any direct benefit to any other entity; wherein the collaborative advertisement type is selected from the group consisting of display, television, radio, internet, direct mail, print, and promotional; and, wherein the website provides interested parties the ability to view or listen to collaborative advertisements produced and information about the entities that produced them.

### BRIEF DESCRIPTION OF THE DRAWINGS

The drawings, when considered in connection with the following description, are presented for the purpose of facilitating an understanding of the subject matter sought to be protected.

FIG. 1 is a schematic of a collaborative advertisement produced under the umbrella of a third party charitable organization as described herein;

FIGS. 2A, 2B and 2C is a schematic of various web pages of a third party charitable organization;

FIG. 3 is a schematic of a method of producing a collaborative advertising campaign under the umbrella of a third party charitable organization when an advertising agency represents the two corporations that are interested in participating in a collaborative advertising campaign;

FIGS. 4A and 4B is a schematic of a method of producing a collaborative advertising campaign under the umbrella of a third party charitable organization when the advertising agency represents only one of the two corporations that are interested in participating in a collaborative advertising campaign;

FIGS. 5A and 5B is a schematic of a method of producing a collaborative advertising campaign under the umbrella of a third party charitable organization when the advertising agency does not represent either of the two corporations interested in the collaborative advertising campaign;

FIGS. 6A and 6B is a schematic of a method of producing a collaborative advertising campaign under the umbrella of a third party charitable organization when a corporation is interested in participating in a collaborative advertising campaign; and,

FIGS. 7A, 7B and 7C are schematics of the forms referred to in FIGS. 3-6B.

### DETAILED DESCRIPTION

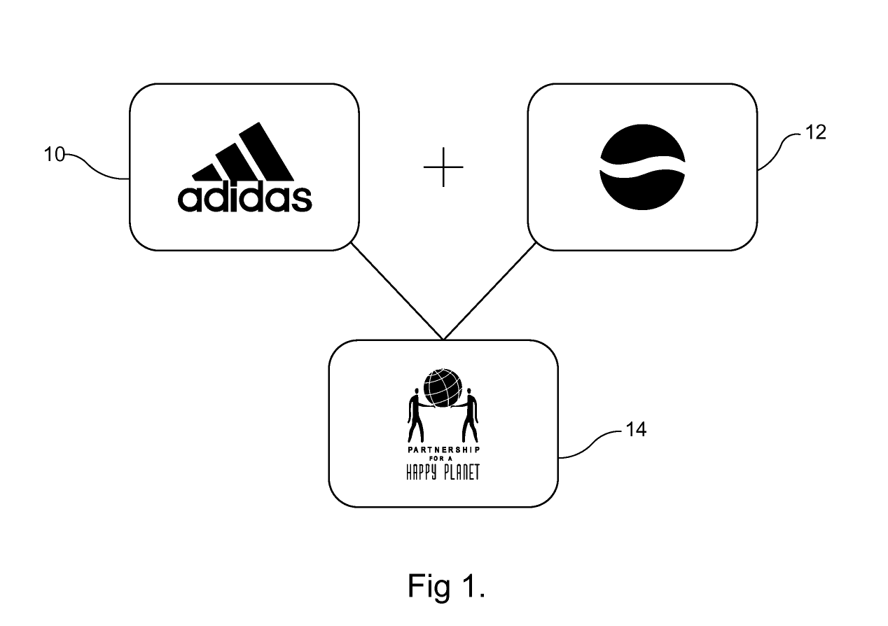

FIG. 1 is a schematic of a collaborative advertisement produced under the umbrella of a third party charitable organization as described herein. As shown, a first autonomous 10 and second autonomous entity 12 come together to generate some form of advertisement where the entities share substantially all the costs for the production of the advertisement and/or media buy in some proportion and, wherein each entity does so with the sole intent of benefiting individually and without regard to any direct benefit to any other entity. This type of advertisement would be considered a collaborative advertisement rather than a co-operative advertisement for the reasons described above. Two entities are “autonomous” when their products or services are not directly related to each other in some way. This is one of the main distinctions when compared to co-operative advertising. In the example provided above, the collaborative advertisement would be a television advertisement jointly paid for by Adidas and Pepsi (two autonomous entities) where a person is shown running in his new Adidas running shoe, and once she arrives at her destination, she is handed a Pepsi to quench her thirst. The fact that a consumer after seeing the advertisement goes out and buys a pair of Adidas running shoes has no effect on Pepsi. The result would be the same if the consumer only purchased a Pepsi. Thus, this ad would meet the criteria of a collaborative advertisement.

Collaborative advertisements may be of any type that is commonly used by entities to promote their goods and services and include, but are not limited to, display, television, radio, internet, direct mail, print, and promotional advertising.

As described more specifically above, FIG. 1 is a schematic of a collaborative advertisement produced under the umbrella of a third party charitable organization. The term “under the umbrella” is referred to herein as meaning that the third party charitable organization endorses the collaborative advertisement, the entities, and has essentially provided its “seal of approval.” In this example, the charitable organization's 14 endorsement of the advertisement and the entities is accomplished by displaying the third party organization's logo at the end of the advertisement. It should be appreciated that the endorsement could be applied in any number of ways to the advertisement. In order to garner the endorsement, certain conditions must be met, including, but not limited to, the companies involved with the collaborative advertisement must meet certain criteria. Examples of such criteria may include: 1) that the company has produced or is in the process of producing a product/service/technology/method of doing business that is environmentally and socially conscious; and 2) the company will make a financial contribution to the charity/charities endorsed by the charitable organization.

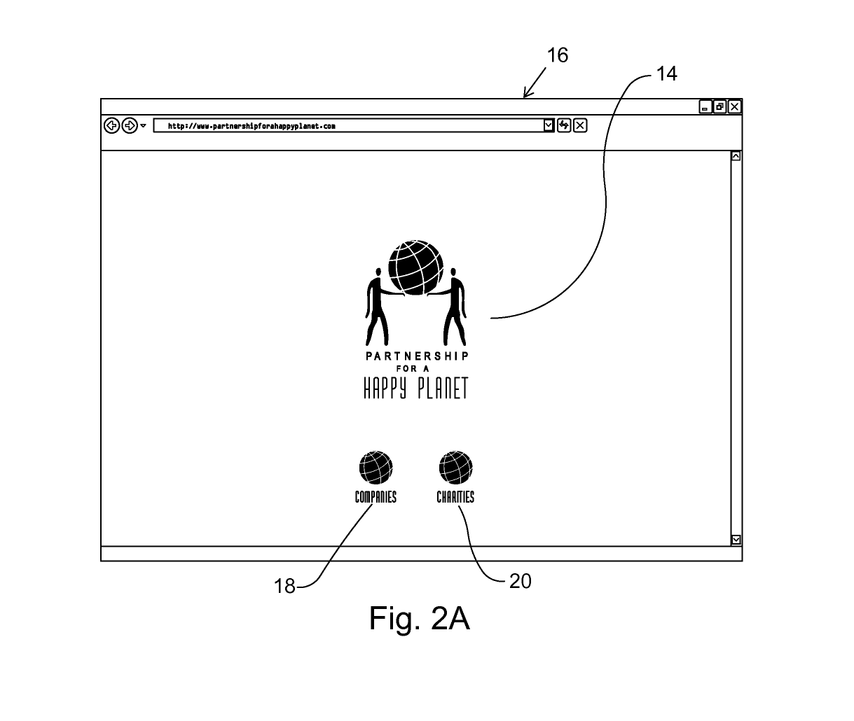

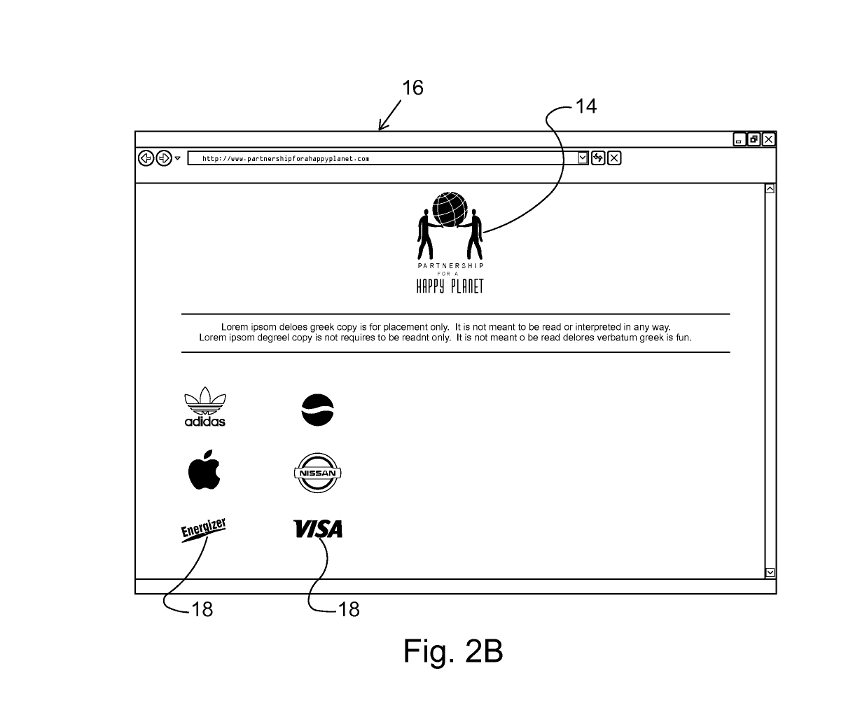

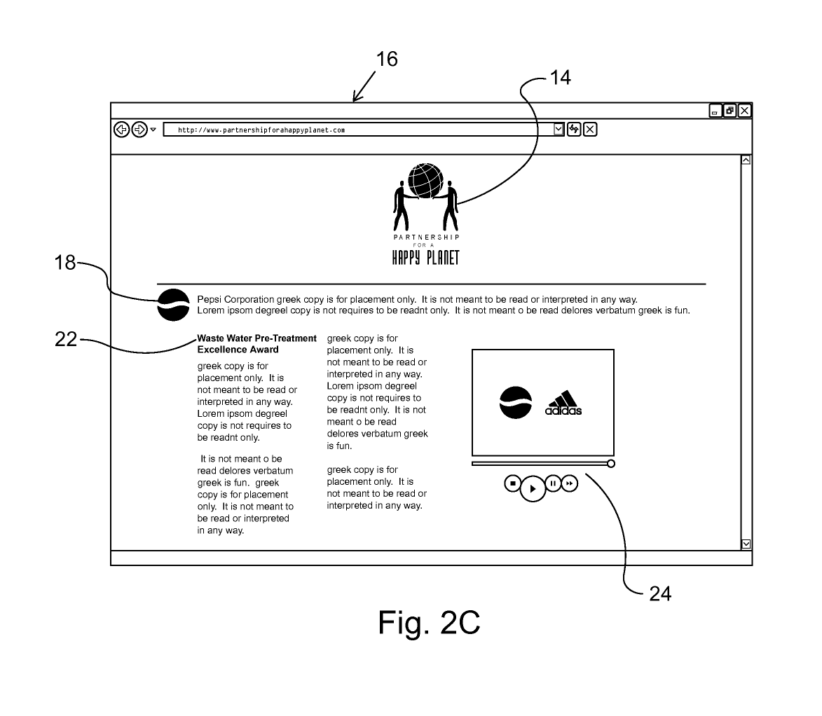

Preferably, the charitable organization does more than just endorse the advertisement. For example, the charitable organization may utilize means to bring at least one of entities together for the production of the collaborative ad. One such means is a website. Referring now to FIGS. 2A, 2B, and 2C shown therein is a schematic of various web pages of a third party charitable organization utilized at least in part to bring entities interested in producing a collaborative ad together. It should be appreciated, and it is contemplated in this disclosure, that the third party organization need not have a charitable purpose.

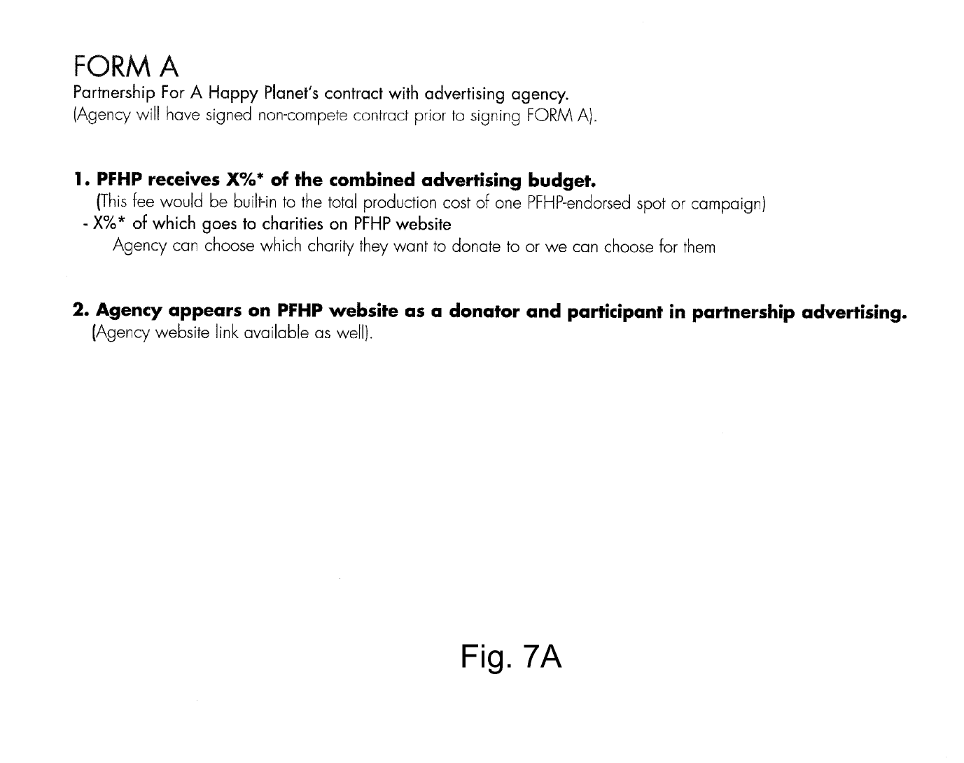

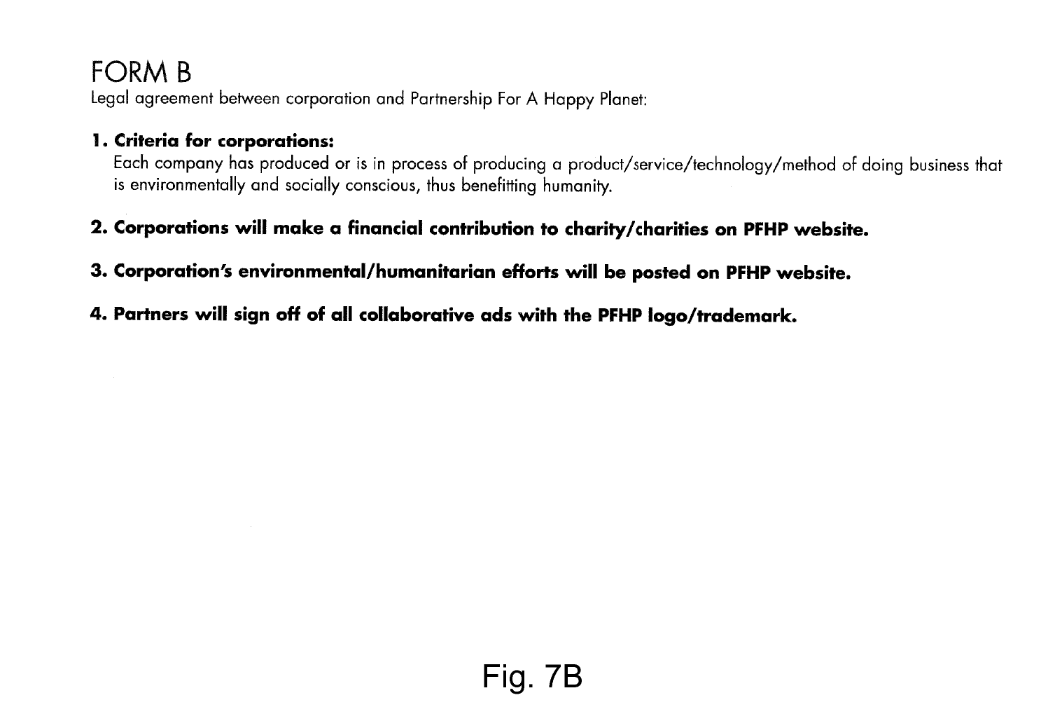

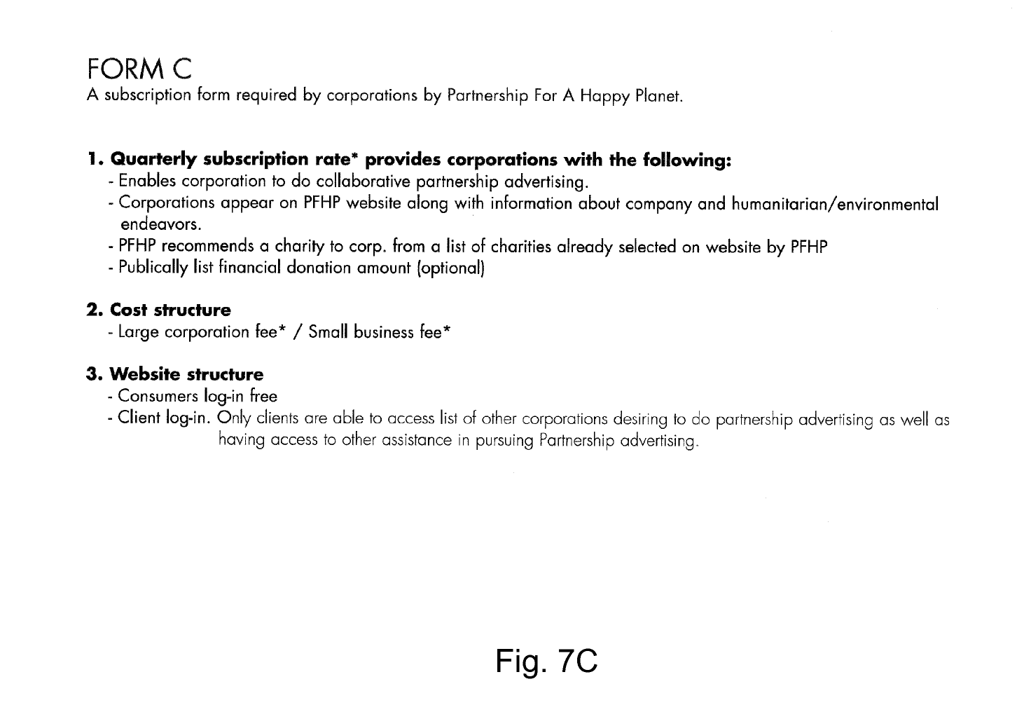

FIG. 2A is a schematic of a potential webpage 16 of a third party charitable organization 14, the page 16 shown provides a first icon for entities/corporations 18 to select to view or join the site and a second icon for charities 20 to select to view or join the site. Companies would want to join the site in order to receive a variety of benefits including: 1) being listed on a website operated by the third party charitable organization for the purpose of creating collaborative ads facilitates that opportunity for the company to create such ad with other interested companies; 2) the website would also provide entities the ability to list their charitable contributions; 3) have a venue to exhibit their collaborative ads to consumers to watch or listen to; and 4) and to further benefit the entity, the website would indicate that in order for the entities to be listed on the website, they must have met certain criteria set by the third party charitable organization. Examples of such criteria may include: 1) that the company has produced or is in the process of producing a product/service/technology/method of doing business that is environmentally and socially conscious; and 2) the company will make a financial contribution to the charity/charities endorsed by the charitable organization. See FIG. 7B.

FIG. 2B may be an example of a webpage 16 that is used to show what other entities are interested in collaborative advertising. Once the icon representing the entity is selected, a page that indicates the approximate advertising budget of the entity would be displayed, along with other information that could be used by the viewer (in this case, another entity or advertising agency) to determine if that entity would be a compatible partner for a collaborative ad. Alternatively, or in addition to, FIG. 2B may be an example of a webpage 16 that may used to show what entities have met the criteria of the charitable organization. Thus, this information would be important to environmentally and socially conscious consumers or other interested parties that view the website. In this example, once the icon representing the entity is selected, a page 16 for that entity is brought up that lists the companies charitable/environmental purposes 22 and also allows the consumer/interested parties to listen to or view collaborative ads 24 produced by the entity. To obtain such benefits, the entities pay a fee to the third party charitable organization to be listed on its website.

The charities 20 would also benefit by being part of the website 16. For example, such listed charities would receive the benefit of: 1) being recognized as meeting certain criteria set by the third party charitable organization (for example a minimum percentage of donations are used directly for the intended charitable purpose); and 2) receiving a portion of the funds received by the third party charitable organization from the fees it receives. Fees received by the third party charitable organization may include: 1) subscription fees paid by the entities to be listed on the website and/or to view specific information (see FIG. 7C); 2) subscription fees paid by advertising agencies to be listed on the website and/or to view specific information; and 3) a percentage of the total advertising budget of producing the collaborative ad under the umbrella of the third party charitable organization. See FIG. 7A.

As stated briefly above, advertising agencies would also be inclined to receive the benefits of a site provided for the purpose of generating collaborative ads. By simply viewing the site, the ad agency would receive the benefit of determining what entities are interested in producing collaborative advertisements. If the agency subscribes (by paying a fee) to the third party charitable organization's website, the agency would receive the additional benefit of being able to be listed as an agency interested in generating collaborative advertisements and/or has experience in generating such collaborative ads. Other benefits are realized, which should be known by those skilled in the art. Further, it is also contemplated that the advertising agency would be able to be listed on the website and include information about its charitable donations. Such donations may arise out of the production of the collaborative advertisements and/or independent of the advertisements.

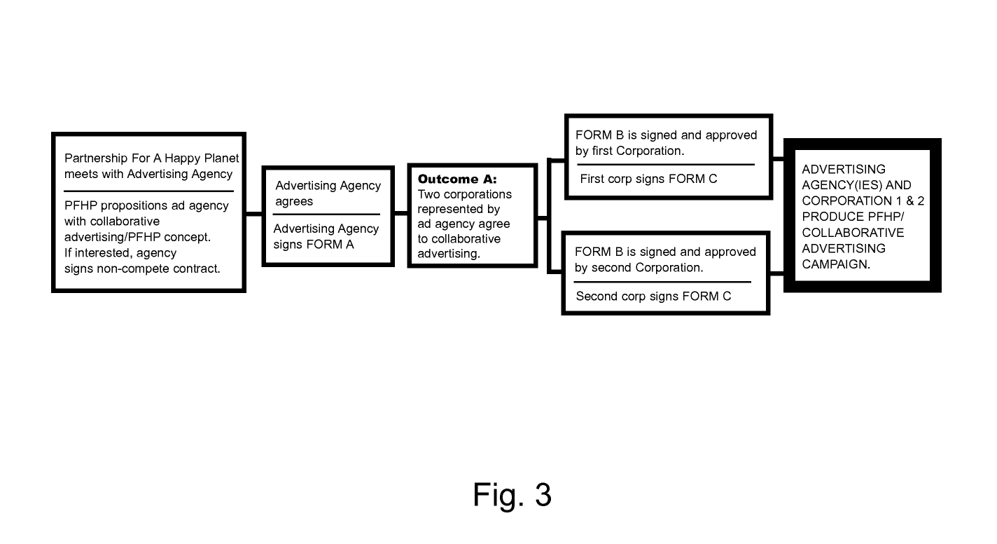

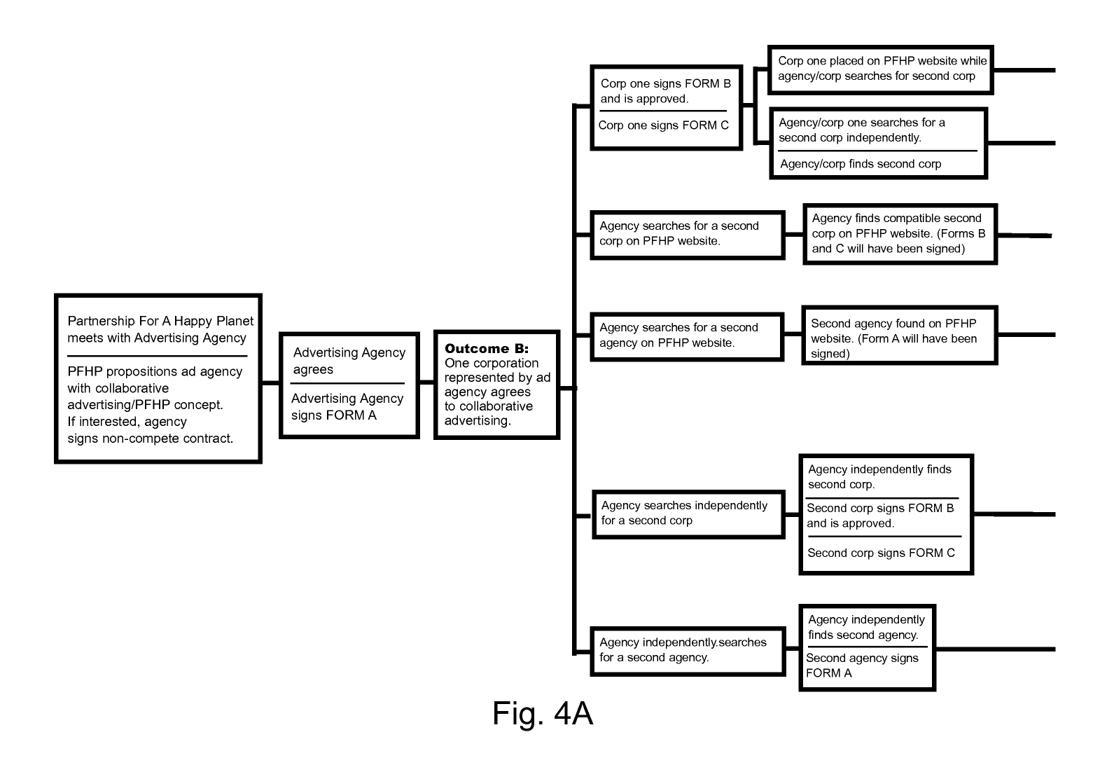

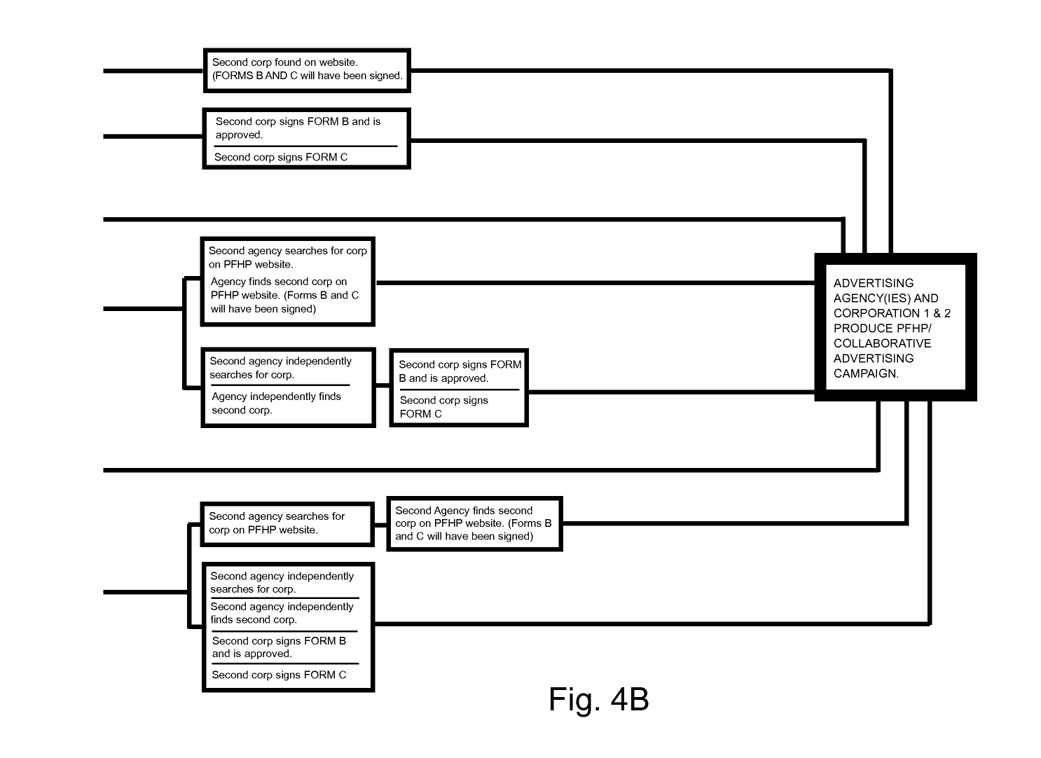

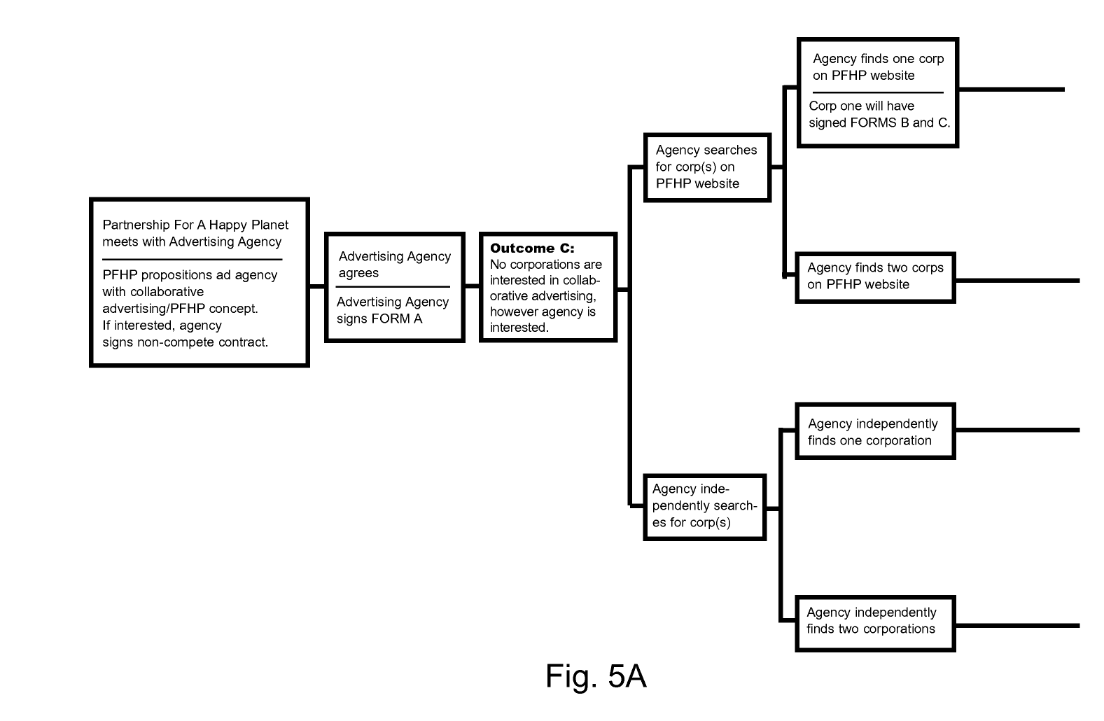

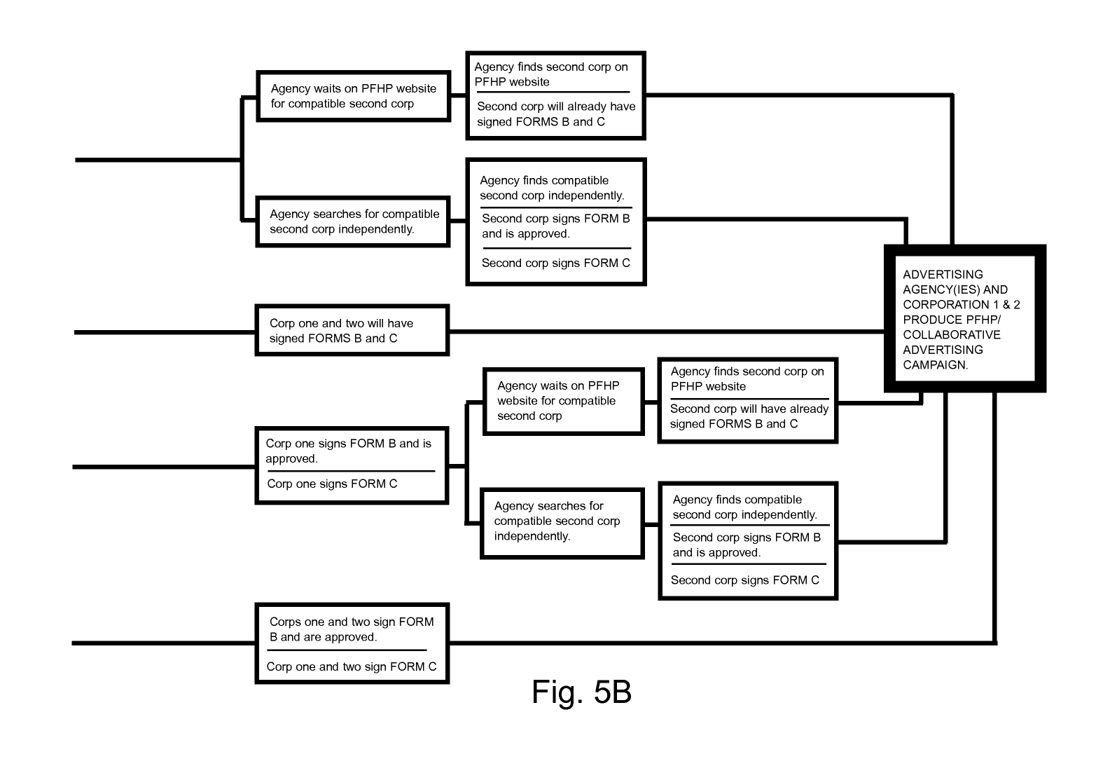

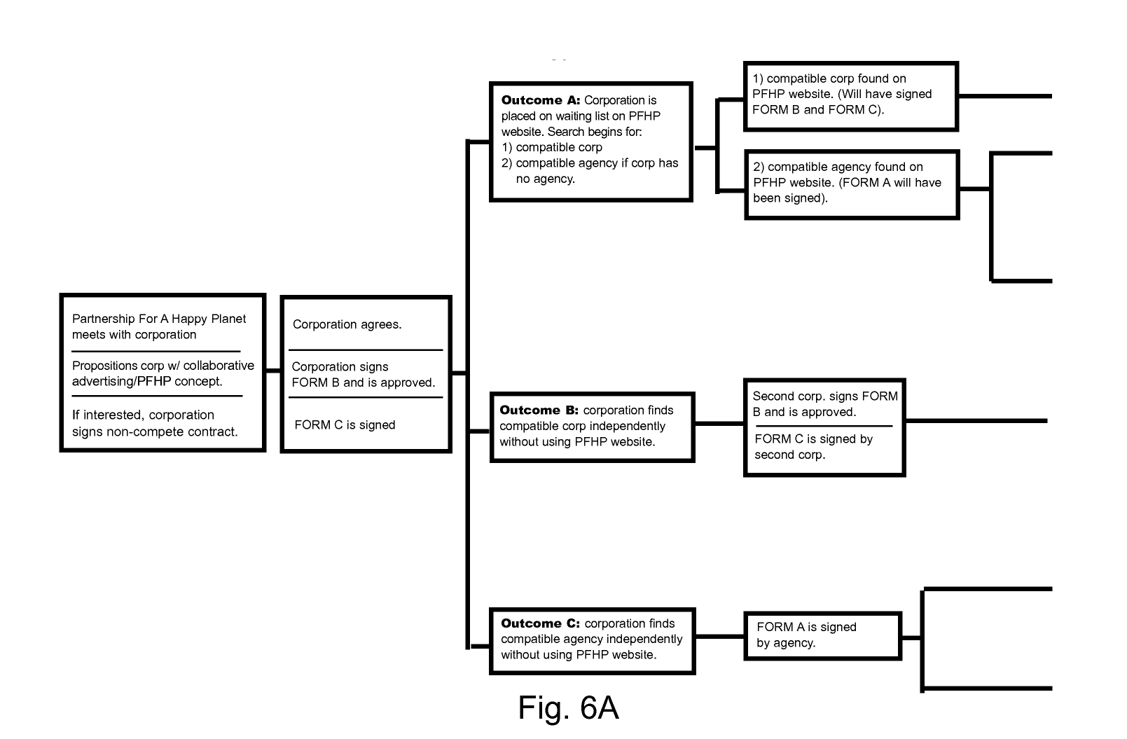

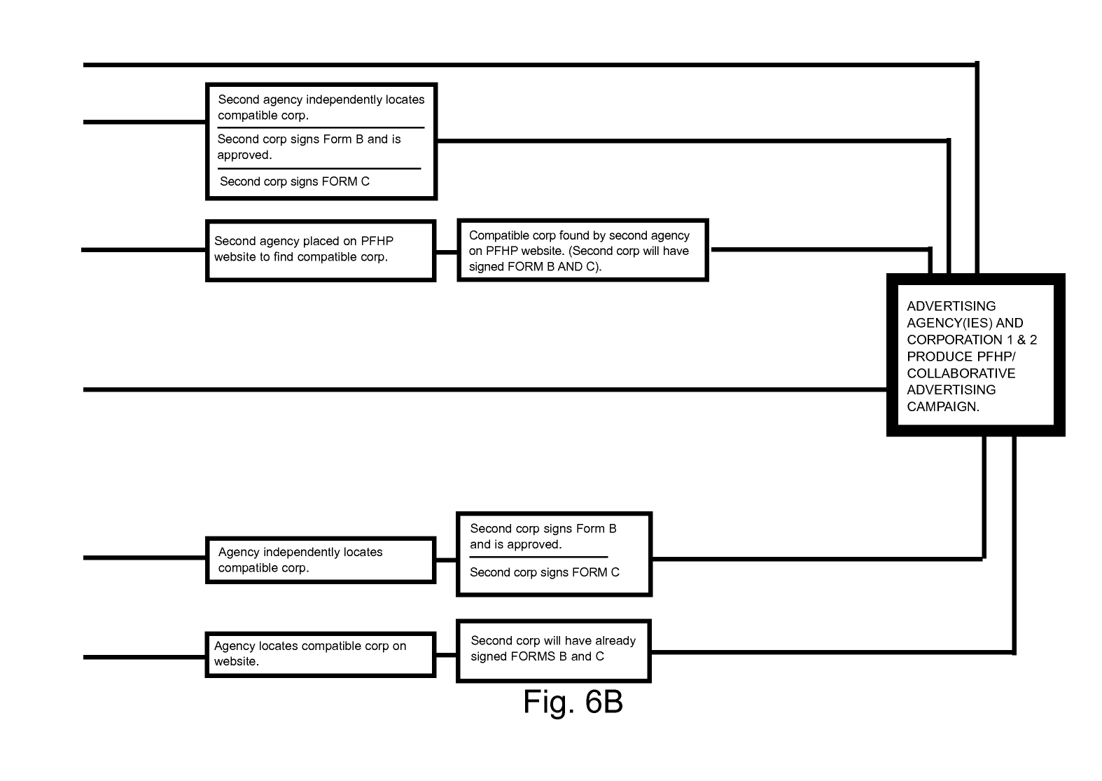

The remaining figures (FIGS. 3-6B) are of sufficient detail such that more than the initial brief description is required and provide examples of how a collaborative advertisement may be produced under various scenarios. To that end, FIG. 3 is a schematic of a method of producing a collaborative advertising campaign under the umbrella of a third party charitable organization when an advertising agency represents the two corporations that are interested in participating in a collaborative advertising campaign. FIGS. 4A and 4B is a schematic of a method of producing a collaborative advertising campaign under the umbrella of a third party charitable organization when the advertising agency represents only one of the two corporations interested in participating in a collaborative advertising campaign. FIGS. 5A and 5B is a schematic of a method of producing a collaborative advertising campaign under the umbrella of a third party charitable organization when the advertising agency does not represent either of the two corporations interested in the collaborative advertising campaign. And FIGS. 6A and 6B is a schematic of a method of producing a collaborative advertising campaign under the umbrella of a third party charitable organization when a corporation is interested in participating in a collaborative advertising campaign.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A method of generating a collaborative advertisement, the method comprising the steps of:
at least two autonomous entities coming together to create an advertisement;
the entities sharing substantially all the costs of the advertisement in some proportion; and,
wherein each entity does so with the sole intent of benefiting individually and without regard to any direct benefit to any other entity.

2. The method of claim 1, wherein the method further comprises the step of:
facilitating the collaborative advertisement by a third party organization.

3. The method of claim 2 wherein the third party organization is a charitable organization.

4. The method of claim 3 wherein the charitable organization sets certain standards before allowing a collaborative advertisement to be produced with its endorsement.

5. The method of claim 1 wherein the collaborative advertisement type is selected from the group consisting of display, television, radio, internet, direct mail, print, and promotional.

6. The method of claim 3 wherein the step of at least two entities coming together to create an advertisement is facilitated through at least one of the entities being listed on a website operated by the third party charitable organization.

7. The method of claim 6 wherein the website provides entities the ability to list their charitable contributions and an indication that the entities listed on the website have met certain criteria set by the third party charitable organization in order to be listed on the website.

8. The method of claim 7 wherein the website provides interested parties the ability to view or listen to collaborative advertisements produced and information about the entities that produced them.

9. The method of claim 6 wherein the website provides advertising agencies the ability to view entities interested in producing collaborative advertisements and the ability to be listed as agencies interested in generating collaborative advertisements.

10. The method of claim 3 wherein the step of sharing the costs associated with producing the collaborative advertisement further comprises the step of providing the charitable organization a fee for the advertisement to be produced with its endorsement.

11. The method of claim 7 wherein the entities pay a fee to the charitable organization to be listed on its website.

12. A method of generating a collaborative advertisement under the umbrella of a third party charitable organization, the method comprising the steps of:
at least two autonomous entities coming together to create an advertisement, wherein at least one of the entities is listed on a website operated by the third party charitable organization, wherein the website provides entities the ability to list their charitable contributions and an indication that the entities listed on the website have met certain criteria set by the third party charitable organization in order to be listed on the website;
the entities sharing substantially all the costs of the advertisement in some proportion;
wherein each entity does so with the sole intent of benefiting individually and without regard to any direct benefit to any other entity; and,
wherein the collaborative advertisement type is selected from the group consisting of display, television, radio, internet, direct mail, print, and promotional.

13. The method of claim 12 wherein the step of sharing the costs associated with producing the collaborative advertisement further comprises the step of providing the charitable organization a fee for the advertisement to be produced with its endorsement.

14. The method of claim 13 wherein the entities pay a fee to the charitable organization to be listed on its website.

15. A method of facilitating a collaborative advertisement by a third party organization, the method comprising the steps of:
at least two autonomous entities coming together to create an advertisement; wherein at least one of the entities is listed on a website operated by the third party organization;
the entities sharing substantially all the costs of the advertisement in some proportion;
wherein each entity does so with the sole intent of benefiting individually and without regard to any direct benefit to any other entity;
wherein the collaborative advertisement type is selected from the group consisting of display, television, radio, internet, direct mail, print, and promotional; and,
wherein the website provides interested parties the ability to view or listen to collaborative advertisements produced and information about the entities that produced them.

16. The method of claim 15 wherein the step of sharing the costs associated with producing the collaborative advertisement further comprises the step of providing the organization a fee for the advertisement to be produced.

17. The method of claim 15 wherein the entities pay a fee to the organization to be listed on its website.

18. The method of claim 16 wherein the entities pay a fee to the organization to be listed on its website.

19. The method of claim 15 wherein the website further provides advertising agencies the ability to view entities interested in producing collaborative advertisements and the ability to be listed as agencies interested in generating collaborative advertisements.

20. The method of claim 16 wherein the advertising agencies pay a fee to the organization to be listed on its website or to view the entities interested in producing collaborative advertisements.
